(19) United States
(12) Patent Application Publication
(10) Pub. No.: US 2016/0269341 A1
(43) Pub. Date: Sep. 15, 2016

(54) DISTRIBUTION OF ENDORSEMENT INDICATIONS IN COMMUNICATION ENVIRONMENTS

(71) Applicant: Microsoft Technology Licensing, LLC, Redmond, WA (US)

(72) Inventors: Santosh Kumar, Sammamish, WA (US); Giselli Panontini DeSouza Sana, Redmond, WA (US); Alisson Teixeira, Seattle, WA (US); Amit Gupta, Redmond, WA (US); Cindy Kwan, Bellevue, WA (US); Sangya Singh, Redmond, WA (US); Naresh Sundaram, Redmond, WA (US); Johannes Gehrke, Bellevue, WA (US)

(21) Appl. No.: 14/737,658

(22) Filed: Jun. 12, 2015

Related U.S. Application Data
(60) Provisional application No. 62/131,816, filed on Mar. 11, 2015.

(51) Int. Cl. H04L 12/58

(52) U.S. Cl. CPC H04L 51/24; H04L 51/32; H04L 51/34

(57) ABSTRACT

Communication services enable users to communicate electronically over communication exchange channels using multiple modes of communication. Conversations between groups of users are common, where many communications may be exchanged repeatedly over a period of time. In some scenarios, a communication desired to be conveyed by a participant in a conversation may be a simple endorsement, such as receipt acknowledgment and various levels of social activity actions and/or gestures, which may be useful for other participants of the conversation to see as well. An endorsement indication based on the participant selected endorsement may be transmitted to the other participants of the conversation over a designated communication channel. The designated communication channel may be a control messaging channel in a transport layer of a communication service, for example, that is distinct from the communication exchange channels such that normal communication traffic may be unaffected by the distribution of the endorsement indication.

### CROSS-REFERENCE TO RELATED APPLICATION

This application claims benefit under 35 U.S.C §119 (e) of U.S. Provisional Application Ser. No. 62/131,816 filed on Mar. 11, 2015. The Provisional Application is herein incorporated by reference in its entirely.

### BACKGROUND

Communication service and/or applications enable two or more users to communicate electronically using multiple modes of communication such as email, text messaging, media exchange, audio communication, video communication, desktop sharing, data sharing, application sharing, and similar modes. Some communication services and/or applications include additional functionality such as scheduling, contact list management, task management and comparable ones. Conversations between groups of users are common, where emails, other communications, and data are exchanged repeatedly over a period of time. In some scenarios, a message desired to be conveyed by a participant in a conversation may be a simple endorsement or acknowledgment, which may be useful for other participants to see as well. However, a reply or reply-all type communication would cause an entire message to be resent to all participants causing unnecessary network bandwidth and data storage consumption.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Embodiments are directed to distribution of endorsement indications in communication environments. A selection of an endorsement for an exchanged communication by a recipient of the exchanged communication may be detected, an endorsement indication based on the selected endorsement may be transmitted to a sender and one or more other recipients of the exchanged communication over a designated communication channel that is distinct from one or more communication exchange channels over which communications are exchanged, and the endorsement indication may be provided as a message and a notification such that display of the endorsement indication may be enabled through communication user experiences associated with the sender and the other recipients of the exchanged communication.

These and other features and advantages will be apparent from a reading of the following detailed description and a review of the associated drawings. It is to be understood that both the foregoing general description and the following detailed description are explanatory and do not restrict aspects as claimed.

### BRIEF DESCRIPTION OF THE DRAWINGS

FIG. 1 includes a conceptual diagram illustrating an example communication environment where endorsement indications may be distributed;

FIG. 2 includes a conceptual diagram illustrating an example process for distributing endorsement indications;

FIG. 3A illustrates an example endorsement selection through a communication user experience;

FIG. 3B illustrates an example of endorsement indications displayed through a communication user experience following distribution;

FIG. 4 is a simplified networked environment, where embodiments may be implemented;

FIG. 5 illustrates a general purpose computing device, which may be configured to distribute endorsement indications according to embodiments; and

FIG. 6 illustrates a logic flow diagram for an example process to distribute endorsement indications in communication environments, according to embodiments.

### DETAILED DESCRIPTION

As briefly described above, a response to a communication desired to be conveyed by a participant in a conversation may be a simple endorsement, which may be useful for other participants of the conversation to see as well. Endorsements in communication environments, ranging from receipt acknowledgment to various levels of social activity actions, may enable the participant to convey such an acknowledgement and/or social activity action for the communication without explicitly replying. An endorsement indication based on a selected endorsement may be transmitted to the other participants of the communication or conversation, and displayed through communication user experiences associated with the other participants in order to provide notification of the endorsement to the other participants. The endorsement indication may be transmitted to the other participants over a designated communication channel that is distinct from exchange communication channels through which the communications are exchanged. For example, the designated communication channel may be a control messaging channel in a transport layer of a communication service, for example. The endorsement indication may be distributed to individual mailboxes associated with the other participants and/or to a shared mailbox associated with a group, for example, if the other participants belong to a same group.

In the following detailed description, references are made to the accompanying drawings that form a part hereof, and in which are shown by way of illustrations specific embodiments or examples. These aspects may be combined, other aspects may be utilized, and structural changes may be made without departing from the spirit or scope of the present disclosure. The following detailed description is therefore not to be taken in a limiting sense, and the scope of the present invention is defined by the appended claims and their equivalents.

While the embodiments will be described in the general context of program modules that execute in conjunction with an application program that runs on an operating system on a computing device, those skilled in the art will recognize that aspects may also be implemented in combination with other program modules.

Generally, program modules include routines, programs, components, data structures, and other types of structures that perform particular tasks or implement particular abstract data types. Moreover, those skilled in the art will appreciate that embodiments may be practiced with other computer system configurations, including hand-held devices, multiprocessor systems, microprocessor-based or programmable consumer electronics, minicomputers, mainframe computers, and comparable computing devices. Embodiments may also be practiced in distributed computing environments where tasks are performed by remote processing devices that are linked through a communications network. In a distributed computing environment, program modules may be located in both local and remote memory storage devices.

Embodiments may be implemented as a computer-implemented process (method), a computing system, or as an article of manufacture, such as a computer program product or computer readable media. The computer program product may be a computer storage medium readable by a computer system and encoding a computer program that comprises instructions for causing a computer or computing system to perform example process(es). The computer-readable storage medium is a computer-readable memory device. The computer-readable memory device includes a hardware device that includes a hard disk drive, a solid state drive, a compact disk, and a memory chip, among others. The computer-readable storage medium can for example be implemented via one or more of a volatile computer memory, a non-volatile memory, a hard drive, and a flash drive.

Throughout this specification, the term “platform” may be a combination of software and hardware components to provide a communication application or service with endorsement indications. Examples of platforms include, but are not limited to, a hosted service executed over a plurality of servers, an application executed on a single computing device, and comparable systems. The term “server” generally refers to a computing device executing one or more software programs typically in a networked environment. However, a server may also be implemented as a virtual server (software programs) executed on one or more computing devices viewed as a server on the network. More detail on these technologies and example embodiments may be found in the following description.

A computing device, as used herein, refers to a device comprising at least a memory and a processor that includes a desktop computer, a laptop computer, a tablet computer, a smart phone, a vehicle mount computer, or a wearable computer. A memory may be a removable or non-removable component of a computing device configured to store one or more instructions to be executed by one or more processors. A processor may be a component of a computing device coupled to a memory and configured to execute programs in conjunction with instructions stored by the memory. An operating system may be a system configured to manage hardware and software components of a computing device that provides common services and applications. An integrated module is a component of an application or service that is integrated within the application or service such that the application or service is configured to execute the component. A computer-readable memory device may be a physical computer-readable storage medium implemented via one or more of a volatile computer memory, a non-volatile memory, a hard drive, a flash drive, a floppy disk, or a compact disk, and comparable hardware media that includes instructions thereon to automatically save content to a location. A user experience may be a visual display associated with an application or service through which a user interacts with the application or service. A user action, such as a user selection, refers to an interaction between a user and a user experience of an application or a user experience provided by a service that includes one of touch input, gesture input, voice command, eye tracking, gyroscopic input, pen input, mouse input, and keyboards input. An application programming interface (API) may be a set of routines, protocols, and tools for an application or service that enable the application or service to interact or communicate with one or more other applications and services managed by separate entities.

An endorsement, as used herein, refers to one of a receipt acknowledgement of a communication and/or a social activity action associated with the communication, such as a mention, and a like or a dislike at various levels (e.g., like, like much, like very much, etc.) selected by a participant of the communication. An endorsement indication, as used herein, refers to a brief message or notification transmitted to one or more other participants of the communication, indicating the participant's receipt acknowledgment of the communication and/or a social activity selected by the participant. The endorsement indications are not limited to the examples provided herein. Similarly, communications in which endorsement indications may be used are not limited to emails or comparable text-based messaging. Other communications may include appointments/meetings, contacts, tasks, online conferences, audio/video communications, application sharing sessions, a desktop sharing sessions, and data sharing sessions, for example. Indeed, any form of electronic communication medium may be used to implement endorsement indications.

A designated communication channel, as used herein, refers to a communication channel that is distinct from one or more communication channels, such as communication exchange channels, through which communications are exchanged. For example, the designated communication channel may be a control messaging channel in a transport layer of the communication service. The designated communication channel is not limited to the examples provided herein.

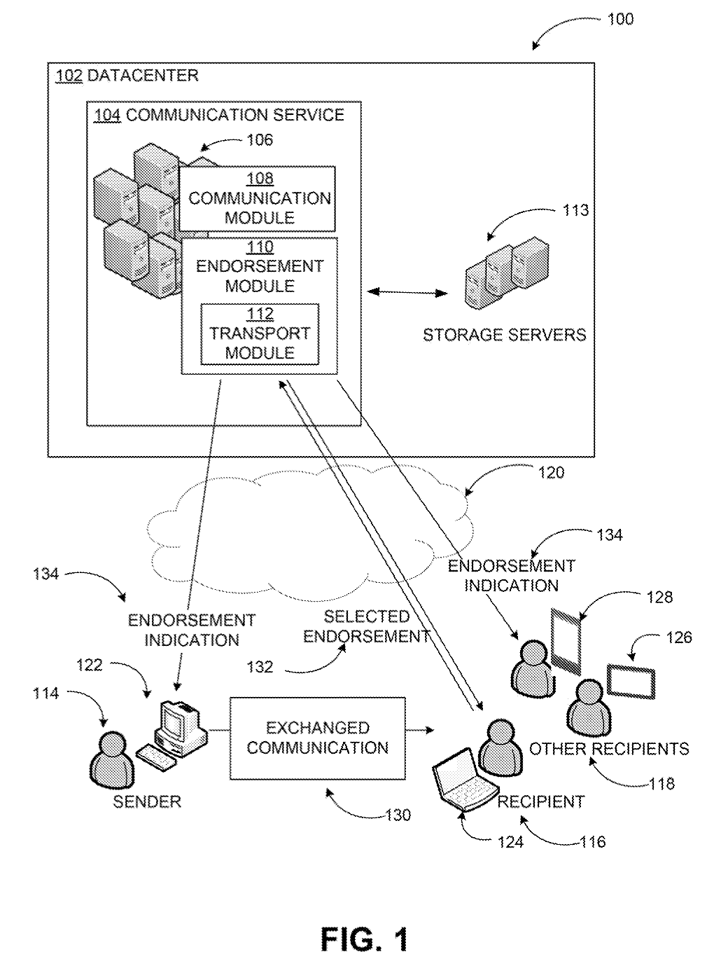

FIG. 1 includes a conceptual diagram illustrating an example communication environment, where endorsement indications may be distributed. As illustrated in diagram 100, an example system may include a datacenter 102 hosting a communication service 104 configured to provide communication-based services to users in various modalities such as email, text messaging, audio/video conferencing, application sharing, desktop sharing, and the like. The datacenter 102 may include one or more processing servers 106, of which, at least one may be operable to execute a communication module 108, an endorsement module 110, and a transport module 112 associated with the endorsement module 110, among other modules. The transport module 112 may be integrated with the endorsement module 110, as illustrated, or the transport module 112 may be a separate module from the endorsement module 110. The datacenter 102 may also include one or more storage servers 113 configured to manage one or more data stores comprising data associated with the communication module 108 and the endorsement module 110. As described herein, the modules of the communication service 104 may be implemented as software, hardware, or combinations thereof.

As illustrated in the diagram 100, the endorsement module 110 and associated transport module 112 may be an integral part of the communication service 104. A client may be a thin client (e.g., a web browser) or a thick (e.g., a locally installed client application) client, enabling a participant of a conversation, such as a sender 114 or one or more recipients 116, 118, to access the communication service 104 over one or more networks such as network 120 via execution of the thin or thick client through an associated computing device. The associated computing device may include a desktop computer 122, a laptop computer 124, a tablet computer 126, a vehicle mount computer, a smart phone 128, or a wearable computing device, among other similar devices. If the client is a thin client, the endorsement module 110 and the transport module 12 of the communication service 104 may be configured to provide and distribute endorsement indications, respectively. If the client is a thick client, the thick client may include a separate, corresponding endorsement module and transport module that work in conjunction with the endorsement module 110 and the transport module 112 of the communication service 104 to provide and distribute endorsement indications, for example. Alternatively, the endorsement module 110 and transport module 112 may not be an integral part of the communication service 104. Instead, the thick client may have a separate endorsement module and transport module communicatively coupled to the endorsement modules and transport modules of other thick clients to facilitate provision and distribution of endorsement indications among participants of the conversation.

Endorsement functionality may be provided across conversation client endpoints. In some examples, the endorsement module 110 and associated transport module 112 may be configured as an extension to an API of the communication service 104 so any third party application may use the framework to build endorsement functionality by connecting to the communication distribution mechanism. As such, communication clients, via execution of the endorsement module 110 and associated transport module 112, may enable selection of endorsements against any communication/conversation in a user mailbox and distribution of endorsement indications for display over a designated communication channel.

In an example embodiment, the communication module 108 may facilitate an exchange of communications over one or more communication exchange channels. For example, the communication module 108 may facilitate exchange of a communication 130 between the sender 114 and the recipients 116, 118. The exchanged communication 130 may be an email exchange, a meeting invite, a shared contact card, a shared task, a text message exchange, an online conference, an audio communication, a video communication, an application sharing session, a desktop sharing session, and a data sharing session, for example. A communication user experience associated with the communication service 104 may be configured to display the exchanged conversations and/or communications associated with an individual mailbox of a user, such as the sender 114 or the recipients 116, 118, and/or a shared mailbox between multiple users. The mailbox may be a server, for example, configured to store exchanged communications, including both received and sent communications, as well as draft communications and deleted communications, among other communications.

The endorsement module 110 may enable a recipient 116 of the exchanged communication 130 to select an endorsement 132 for the exchanged communication 130 through the communication user experience associated with the recipient 116. The selected endorsement 132 may include a receipt acknowledgement and/or a social activity action associated with the exchanged communication 130. The social activity action may include a like, a dislike, and/or a mention, for example, where the recipient 116 may be enabled to select various levels of like and dislike (for example, like, like much, and like very much).

The transport module 112 may detect the selection of the endorsement 132 for the exchanged communication 130 by the recipient 116. The transport module 112 may transmit an endorsement indication 134 based on the selected endorsement 132 to the sender 114 and the other recipients 118 of the exchanged communication over a designated communication channel that is distinct from the communication exchange channels. The designated communication channel may be a control messaging channel in a transport layer of the communication service 104, for example. The endorsement indication 134 may be distributed to individual mailboxes associated with each of the sender 114 and the other recipients 118. Alternatively, the endorsement indication 134 may be distributed to a shared mailbox associated with a group, for example, if the sender 114 and the other recipients 118 belong to a same group.

To achieve such an endorsement indication exchange, the transport module 112 may employ a lightweight and reliable mechanism for inter-mailbox communication. A transport stack that is used to deliver communications to mailboxes may be leveraged to use control messages as a reliable mechanism for inter-server communication. A standard format/schema for the control messages may be employed that distinguish the control messages from exchanged communications. For example, the control messages may include instructions for an action to be performed and metadata associated with the action, where the action may be generation of an endorsement indication and the metadata may include information associated with selected endorsements. A sending component of the transport module 112 may be configured to transmit a control message over the designated communication channel in response to detecting the selection of the endorsement 132 for the exchanged communication 130 by the recipient 116. A receiving component, such as a transport delivery agent, of the transport module 112 may be configured to intercept the control message and process the metadata of the control message to generate the endorsement indication 134. In an example scenario, if the selected endorsement 132 is like, a like agent may intercept a like control message with metadata and process the metadata to create a persisted like endorsement notification in individual mailboxes of the sender 114 and the other recipients 118, and/or the shared mailbox of the group comprising the sender 114 and the other recipients 118. The receiving component may store the endorsement indication 134 in a database associated with the mailboxes such that the endorsement indication may be persisted. To minimize impact of the control messages on service, during periods of high load, the processing/routing of these control messages may be de-prioritized by the transport stack in favor of delivering communications. Furthermore, as control messages are system messages and as such originate from a trusted environment, load on system resources may be further reduced by eliminating the need for processing actions associated with security and/or authentication, like anti-spam, anti-virus etc.

In some embodiments, the transport module 112 may provide the endorsement indication 134 as a message or a notification through a broker component such that the endorsement indication 134 may be displayed through communication user experiences associated with the sender 114 and the one or more other recipients 118 of the exchanged communication 130. The displayed endorsement indication 134 may include identifying information such as the endorser (the recipient 116), the selected endorsement 132, the exchanged communication 130, a group associated with the exchanged communication 130, if applicable, and/or a time elapsed from the selection of the endorsement, for example. In some embodiments, the endorsement indication 134 may be aggregated with one or more other endorsement indications for the exchanged communication 130 at a per communication level such that the sender 114 and the recipients 116, 118 are only notified when a new endorsement is selected for the exchanged communication 130. In some examples, the notification may be based on a last time the sender 114 and the recipients 116, 118 acknowledged a displayed endorsement indication.

Conversations between groups of users, such as the sender 114 and recipients 116, 118 illustrated in FIG. 1, are common, where communications may be exchanged repeatedly over a period of time. Endorsements in communication environments may enable a user in the conversation to simply endorse or acknowledge an exchanged communication (which may be viewed by other users of the conversation through endorsement indications), instead of sending a reply or reply-all type communication that would cause the entire communication to be resent to the other users of the conversation causing unnecessary network bandwidth and data storage consumption. Additionally, distribution of the endorsement indications using a designated communication channel distinct from communication exchange channels may reduce traffic in the communication exchange channels, and thus prevent any potential decrease in service or performance due to a traffic overload. As such, distribution of endorsement indications in communication environments, as described herein, may increase efficiency in network usage by reducing communication traffic, reduce processor usage by reducing need for repeated reply or reply all type communications, and reduce data storage need as the number of reply or reply all type communications stored in individual users' or group mailboxes may be reduced. Furthermore, distribution of endorsement indications in communication environments may improve user efficiency as the users may easily recognize endorsements selected by others through the endorsement indications displayed upon distribution. User interaction performance may also be improved by the persistence of endorsement indications and endorsement-related data enabled through the distribution mechanism.

Embodiments, as described herein, address a need that arises from very large scale of operations created by networked computing and cloud based services that cannot be managed by humans. The actions/operations described herein are not a mere use of a computer, but address results of a system that is a direct consequence of software used as a service such as the communication service 104 offered in conjunction with large numbers of users and exchanged communications.

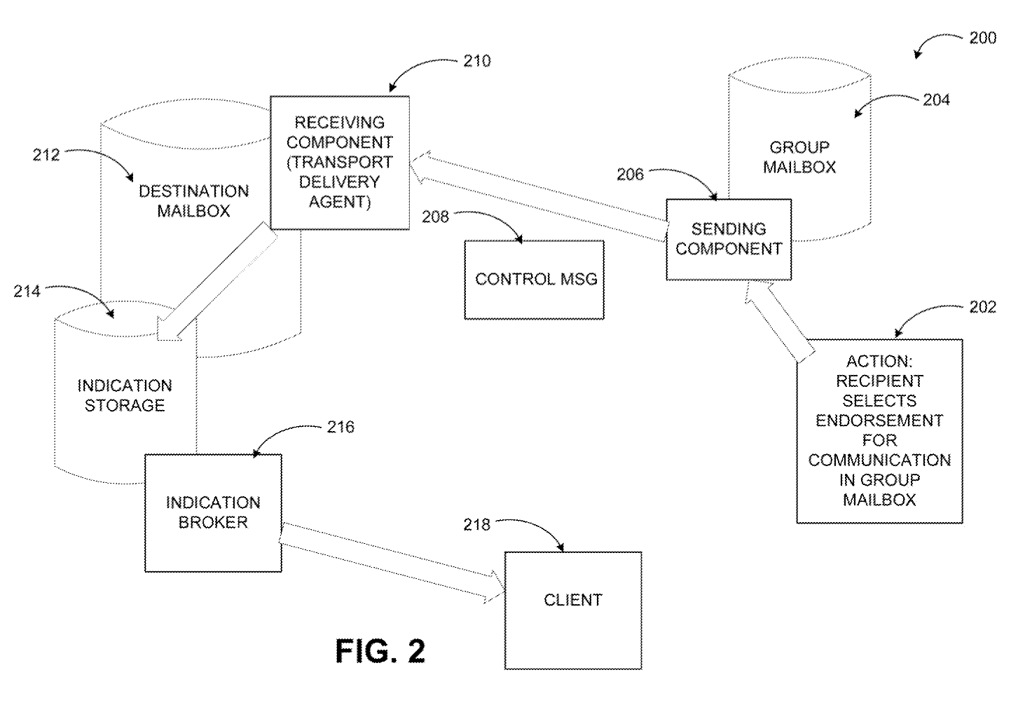

FIG. 2 illustrates a conceptual diagram illustrating an example process for distributing endorsement indications. A communication service may enable two or more users to communicate electronically using various modes of communication. The communication service may include a communication module configured to facilitate exchange of communications over one or more communication exchange channels, and an endorsement module and associated transport module configured to provide and distribute endorsement indications for the exchanged communications, among other modules.

In an example scenario, as illustrated in diagram 200, the transport module may detect a selection of an endorsement for an exchanged communication by a recipient of the exchanged communication 202. The recipient may select the endorsement through a communication user experience displayed by a first server associated with the recipient, the selection facilitated by the endorsement module. The first server may be a computing device, for example, that includes at least a memory, one or more processors, and a communication module that facilitates the exchange of communications, such as the exchanged communication, over a communication exchange channel. The exchanged communication may be stored in a group mailbox 204 at the first server, for example, where the group mailbox 204 may store exchanged conversations and communications associated with a group that includes the recipient, a sender, and one or more other recipients of the exchanged communication. A sending component 206 of the transport module may be configured to route a control message 208 to a destination mailbox 212 at a second server associated with the sender or other recipients of the exchanged communication, for example, over a control messaging channel in a transport layer of the communication service. Similar to the first server, the second server may be a computing device that includes at least a memory, one or more processors, and a communication module that facilitates the exchange of communications over a communication exchange channel. A standard format/schema for the control message 208 may be employed that distinguishes the control message 208 from a normal exchanged communication and contains other relevant data, including instructions for an action to be performed and metadata associated with the action. The action may be to generate an endorsement indication, and the metadata may include information associated with the selected endorsement, such as an endorser (the recipient), a type of endorsement selected, the exchanged communication for which the endorsement was selected, a group associated with the exchanged communication, and a time the endorsement was selected. A receiving component of the transport module, such as a transport delivery agent 210, may intercept the control message 208 and process the metadata associated with the action to create an endorsement indication.

The transport delivery agent 210 may store the endorsement notification in a database 214 associated with the destination mailbox 212 such that the endorsement indication may be persisted at the destination mailbox 212. In some examples, the endorsement indication may be aggregated with one or more other endorsement indications associated with a same exchanged communication within the database 214, for example.

An indication broker 216 of the transport module may be configured to provide the endorsement indication to a client 218 associated with the sender or other recipients, where the client 218 enables the sender or the other recipients to access to the communication service via execution of the client 218 at the second server. The endorsement indication may be provided as one of a message or notification such that the endorsement indication may be displayed through user experiences associated with the communication service. Among other examples, the persistence of the endorsement indication may be useful if the client 218 is not in an online mode, such that the endorsement indication may be consumed later when the client 218 returns to the online mode.

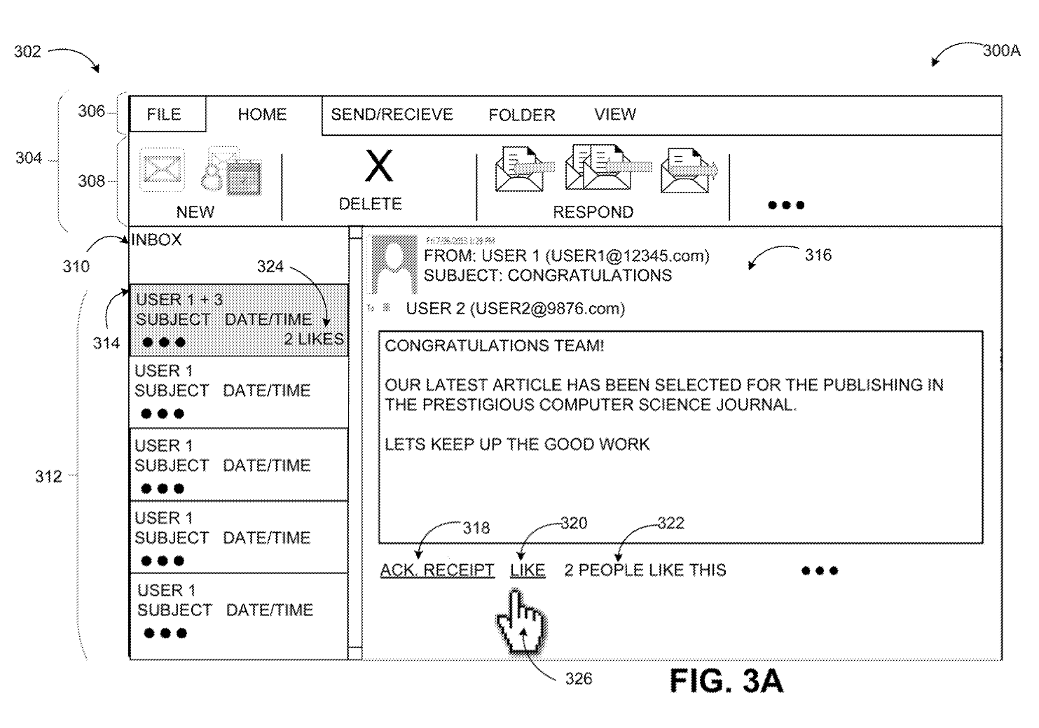

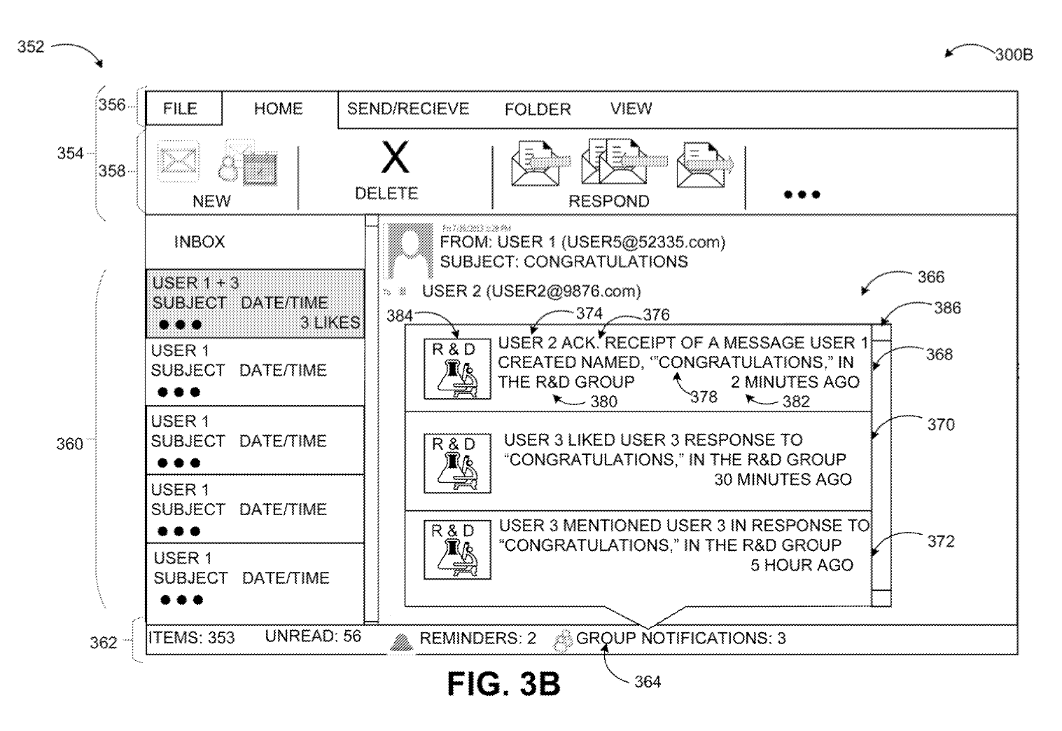

FIG. 3A illustrates an example endorsement selection through a communication user experience. A communication service may enable two or more users to communicate electronically using various modes of communication. The communication service may include a communication module configured to facilitate exchange of one or more communications between participants of a conversation, and an endorsement module associated with a transport module configured to provide and distribute endorsement indications for the exchanged communications, among other modules.

As shown in diagram 300A, a communication user experience 302 associated with a user may include a command bar 304 to enable user interactivity with the communication service. The command bar 304 may employ a textual scheme, a graphical scheme, an audio scheme, an animation scheme, a coloring scheme, a highlighting scheme, and/or a shading scheme, among other schemes, to enhance presentation to the user. The command bar 304 may include one or more tabs 306, such as a file tab, a home tab, a send/receive tab, a folder tab, and a view tab, among other examples. Each of the tabs 306 may include one or more groups 308 comprising graphical control elements that enable the user to perform various actions associated with one or more modules of the communication service. In some examples, the graphical control elements may be associated with icons and/or text-based labels, where the labels may indicate an action associated with the graphical control element.

The communication user experience 302 may also display conversations and/or communications associated with an individual mailbox of the user, where the mailbox may be a server configured to store exchanged communications, including both received and sent communications, as well as draft communications and deleted communications, for example. The mailbox may be configured to store these various communications in categorized folders, such as an inbox, an outbox, sent items, draft items, and deleted items. In some embodiments, a communication may be stored with one or more other communications within a same conversation. The communication user experience 302 may display the conversations and/or communications stored in each folder. For example, the communication user experience 302 may display conversations comprising one or more received communications stored in the inbox 310 in a conversation list view 312. Upon user selection of one of the conversations, such as conversation 314, the one or more communications within the conversation 314, such as email message 316, may be displayed.

The endorsement module of the communication service may enable the user, who is a recipient of the email message 316, for example, to endorse the email message 316 through the communication user experience 302. For example, the endorsement module may enable provision and display of various endorsement options for user selection, such as acknowledge receipt 318 and/or social activity actions, including like 320, dislike, and/or mention in conjunction with the email message 316. The endorsement module may also enable display of an endorsement count 322 for the email message 316 indicating a number of endorsements associated with the email message 316, and an endorsement count 324 for a conversation in the conversation list view 312, where the endorsement count may be a sum of the number of endorsements associated with each communication of the conversation). As illustrated in diagram 300A, the email message 316 may be associated with two endorsements, and as the email message 316 is the only communication of the conversation 314, the endorsement count 324 associated with the conversation 314 is also two. In some embodiments, the endorsement module may also enable display of an endorser list indicating names of participants who have selected the endorsements for each communication or conversation.

In response to the user selection 326 of the like 320 endorsement option, the like 320 may be persisted in the mailbox of the user and the communication user experience 302 may be updated accordingly. For example, the endorsement options for user selection may be updated to modify an endorsement option of like to an endorsement option of unlike to reflect that the user has previously liked the email message 316. Additionally, the acknowledge receipt endorsement option may be removed, as this type of endorsement would be redundant in light of the fact that the user has already liked the email message 316. Furthermore, the endorsement count 322 for the email message 316 may be incremented to three, and the endorsement count 324 for the conversation 314 may be incremented to three to reflect that the user has liked the email message 316.

To enable persistence, as described above, the selected endorsements may be stored according to various models. In a first example model, endorsement related properties such as the endorsement count and the endorser list may be added to the exchanged communication. The endorsement count may be stored as an on-page property and the endorser list may be stored as a dynamic on-page or off-page property dependent on size, where the endorser list may represent each endorser based on the globally unique identifier of the user from a directory service associated with the communication service. When the endorser list is displayed through the communication user experience the globally unique identifiers may be converted to names of the users. In some embodiments, a Boolean flag for the exchanged communication may be used within a mailbox when the user associated with the mailbox is the endorser of the exchanged communication, such that the communication service does not to have to go off-page when retrieving exchanged communications for individual mailboxes regardless of the size of the endorser list.

In a second example model, the endorsement may be added (or removed if the user unlikes the exchanged communication, for example), as an entry/row to a table comprising three columns <ConversationId, MessageId, User>. To determine an endorsement count and endorser list associated with the exchanged communication, a query may be issued to the table. For example, to retrieve a number of endorsements for the exchanged communication, a query for rows matching a <ConversationId> associated with the exchanged communication may be issued, and the row count may be aggregated per <MessageId> associated with the exchanged communication. To retrieve the endorser list for the exchanged communication, the table may be queried by <ConversationId, MessageId> associated with the exchanged communication, where if the number of endorsers is less than n, the endorsement count may be replaced with user names retrieved from the table.

In a third example model, the endorsement count and endorser list may be stored on the exchanged communication. The endorsement count may be stored as an on-page property and the endorser list may be stored as an off-page property. A Boolean flag for the exchanged communication may be used within a mailbox when the user associated with the mailbox endorses the exchanged communication, where the flag may be stored as an on-page property. The endorsement-related properties may be persisted across mailboxes associated with other users participating in the email message 316 and/or conversation 314, such as a sender and one or more other recipients, in a similar manner as described above.

Additionally, in response to the user selection 326 of the like 320 endorsement option, the transport module associated with the endorsement module may employ a lightweight and reliable mechanism for inter-mailbox communication to transmit the endorsement indication. For example, in response to detecting the user selection 326 of the like 320 endorsement option, the transport module may be configured to transmit an endorsement indication based on the selected endorsement to the other participants of the email message 316 over a designated communication channel. The designated communication channel may be distinct from the exchange communication channel over which the email message 316 was exchanged. For example, the designated communication channel may be a control messaging channel in a transport layer of the communication service, where a standard format/schema for control messages may be employed that distinguishes the control messages from normal communications. For example, the control messages may include instructions for an action to be performed and metadata associated with the action, where the action may be to generate the endorsement indication and the metadata may include information associated with selected endorsements. A sending component of the transport module at the mailbox associated with the participant may be configured to transmit a control message over the designated communication channel. A receiving component of the transport module, such as a transport delivery agent, at a destination mailbox may intercept the control messages and process the metadata associated with the action to generate the endorsement indication. As illustrated in diagram 300A, the selected endorsement may be like 320. As such, in response to the user selection 326 of the like 320 endorsement option, a like Agent may intercept a like control message with metadata and process the metadata to create a persisted like endorsement notification in the destination mailbox, such as the individual mailboxes of the other participants, and/or the shared mailbox of the group comprising the other participants. In some examples, processing of the control message by subsequent agents may be suppressed by the transport delivery agent to prevent the control message from ending up in an inbox of the individual mailboxes of the other participants, and/or the shared mailbox of the group.

FIG. 3B illustrates an example of endorsement indications displayed through a communication user experience following distribution. As previously discussed in conjunction with FIG. 3A, an endorsement indication based on the selected endorsement by the participant (a recipient of the email message 316) may be transmitted to the other participants of the email message 316, such as a sender and one or more other recipients, over a designated communication channel employing a lightweight and reliable mechanism for inter-mailbox communication. The endorsement indication may be provided as a message or a notification such that display of the endorsement notification may be enabled through communication user experiences associated with the other participants.

For example, as shown in diagram 300B, communication user experience 352 may be a communication user experience associated with one of the other participants. For example, another recipient of the email message 316. Similar to the communication user experience 302, the communication user experience 352 may include a command bar 354 that includes one or more tabs 356, where each of the tabs 356 may include one or more groups 358 comprising graphical control elements that enable the user to perform various actions associated with one or more modules of the communication service. The communication user experience 352 may display conversations and/or communications associated with an individual mailbox of the participant and/or a shared mailbox of a group to which the participant belongs in a conversation list view 360 associated with one or more folders of the individual and/or group mailbox. The communication user experience 352 may also include a notification bar 362 to further enhance user interactivity with the communication service. The notification bar 362 may include various notifications, such as a number of communications within the mailbox, a number of unread communications, reminders, and/or group notifications 364.

The endorsement indication 368 may be displayed through the communication user experience 352 as one of a message and a notification, enabling the participant to preview the selected endorsement for the email message 316 through the displayed endorsement indication 368. For example, the endorsement indication 368 may be displayed in a notification menu 366, or other type of viewing/reading pane, automatically upon receipt of the endorsement indication 368. Alternatively, the endorsement indication 368 may be displayed in the notification menu 366 in response to a user selection of the group notifications 364 control element on the notification bar 362. In some examples, the notification menu 366 may have scrolling functionality 386 to conserve display space on the communication user experience 352. The endorsement indication 368 may be displayed in conjunction with one or more other endorsement indications 370 and 372. For example, the endorsement indications 368, 370, and 372 may be displayed in a chronological order, with the most recently received endorsement indication (endorsement indication 368) at the top of the notification menu 366. The other endorsement indications 370 and 372 may be for a same exchanged communication, as illustrated, or may be for different exchanged communications within a same conversation. Alternatively, the other endorsement indications 370 and 372 may be for exchanged communications within other conversations the user is a participant of. The endorsement indications 368, 370, and 372 may be aggregated at per communication level such that the participant may be notified only when a new endorsement is selected for a communication. In some examples, the notification may be based on a last time the participant acknowledged a displayed endorsement indication. In some embodiments, the participant may be enabled to navigate directly to a communication by selecting a respective endorsement indication for the communication. For example, the user may select any of endorsement indications 368, 370, and 372 to navigate to the email message 316.

Each of the displayed endorsement indications 368, 370, and 372 may include various components, such as the endorser 374, the endorsement 376 (such as a receipt acknowledgement, a like, and a mention, respectively), the exchanged communication 378, a group associated with the sender/recipients of the communication/conversation 380, if applicable, and a time elapsed since the endorsement was selected 382. In some embodiments, each of the endorsement indications 368, 370, and 372 may also include an icon 384 that may represent the group associated with the participants, as illustrated. In other embodiments, the icon 384 may represent the individual participant that selected the endorsement. For example, the icon 384 may be a photograph and/or avatar of the endorser.

The example scenarios and schemas in FIG. 1 through 3B are shown with specific components, data types, and configurations. Embodiments are not limited to systems according to these example configurations. Distribution of endorsement indications in communication environments may be implemented in configurations employing fewer or additional components in applications and user interfaces. Furthermore, the example schema and components shown in FIG. 1 through 3B and their subcomponents may be implemented in a similar manner with other values using the principles described herein.

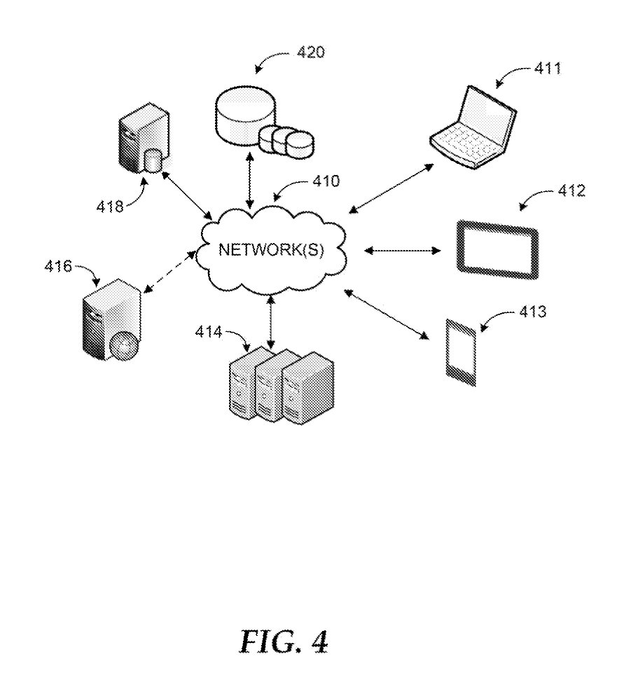

FIG. 4 is an example networked environment, where embodiments may be implemented. A communication service may be implemented via software executed over one or more servers 414 such as a hosted service. The platform may communicate with client applications on individual computing devices such as a smart phone 413, a tablet 412, or a laptop computer 411 (‘client devices’) through network(s) 410.

Client applications executed on any of the client devices 411-413 may facilitate communications via application(s) executed by servers 414, or on individual server 416. A communication module of the communication service may be configured to facilitate exchange of one or more communications such as emails, text messages, online meeting notes/recording, attachments, contact information, calendar items, and similar ones as users communicate through the client devices 411-413, over one or more communication exchange channels over network(s) 410. A transport module associated with an endorsement module of the communication service may be configured to transmit endorsement indications based on selected endorsements for the exchanged communications to participants of the communications over a designated communication channel distinct from the communication exchange channels. The communication service may store data associated with is services, such as endorsement related data, in data store(s) 420 directly or through database server 418.

Network(s) 410 may comprise any topology of servers, clients, Internet service providers, and communication media. A system according to embodiments may have a static or dynamic topology. Network(s) 410 may include secure networks such as an enterprise network, an unsecure network such as a wireless open network, or the Internet. Network(s) 410 may also coordinate communication over other networks such as Public Switched Telephone Network (PSTN) or cellular networks. Furthermore, network(s) 410 may include short-range wireless networks such as Bluetooth or similar ones. Network(s) 410 provide communication between the nodes described herein. By way of example, and not limitation, network(s) 410 may include wireless media such as acoustic, RF, infrared and other wireless media.

Many other configurations of computing devices, applications, data sources, and data distribution systems may be employed to distribute endorsement indications in communication environments. Furthermore, the networked environments discussed in FIG. 4 are for illustration purposes only. Embodiments are not limited to the example applications, modules, or processes.

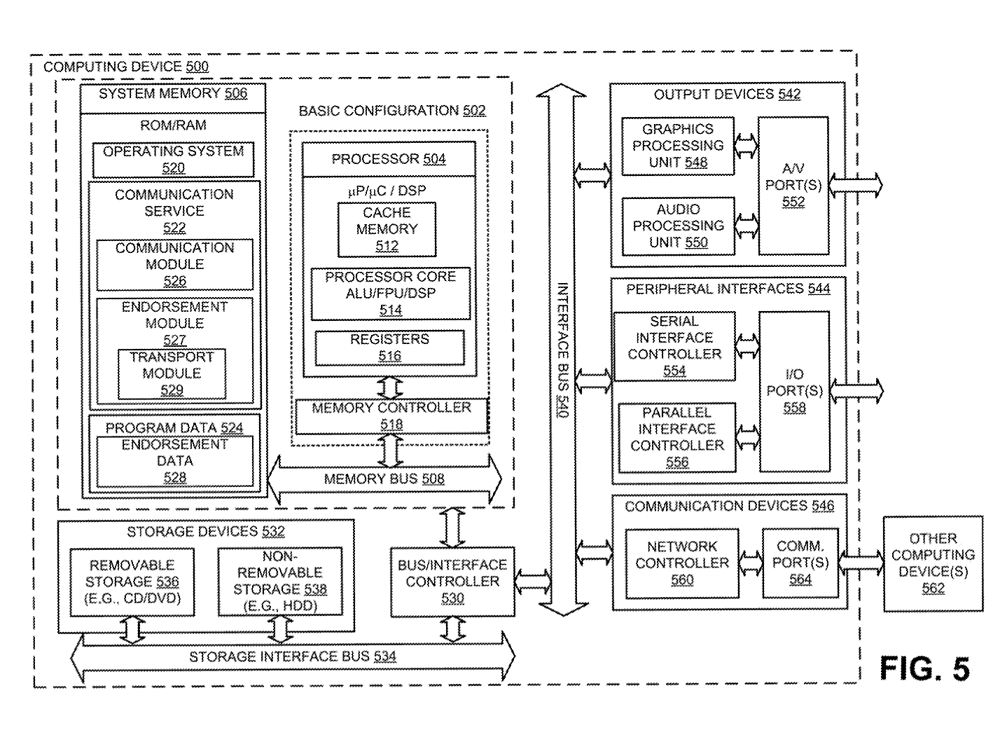

FIG. 5 illustrates a general purpose computing device, which may be configured to distribute endorsement indications in communication environments, arranged in accordance with at least some embodiments described herein.

For example, the computing device 500 may be a server used to provide a communication service as discussed herein. In an example of a basic configuration 502, the computing device 500 may include one or more processors 504 and a system memory 506. A memory bus 508 may be used for communication between the processor 504 and the system memory 506. The basic configuration 502 may be illustrated in FIG. 5 by those components within the inner dashed line.

Depending on the desired configuration, the processor 504 may be of any type, including, but not limited to, a microprocessor (μP), a microcontroller (μC), a digital signal processor (DSP), or any combination thereof. The processor 504 may include one more levels of caching, such as a level cache memory 512, a processor core 514, and registers 516. The processor core 514 may include an arithmetic logic unit (ALU), a floating point unit (FPU), a digital signal processing core (DSP Core), or any combination thereof. A memory controller 518 may also be used with the processor 504, or in some implementations, the memory controller 518 may be an internal part of the processor 504.

Depending on the desired configuration, the system memory 506 may be of any type including but not limited to volatile memory (such as RAM), non-volatile memory (such as ROM, flash memory, etc.), or any combination thereof. The system memory 506 may include an operating system 520, a communication service 522 or application, and a program data 524. The communication service 522 may include a communication module 526, an endorsement module 527, and a transport module 529 associated with the endorsement module 527, which may be an integral part of the communication service 522 or a separate application. The communication module 526 may be configured to facilitate exchange of communications over one or more communication exchange channels. The transport module 529 may be configured to detect a selection of an endorsement for an exchanged communication by a recipient of the exchanged communication (the recipient selection facilitated by the endorsement module 527), and transmit an endorsement indication based on the selected endorsement to a sender and one or more other recipients of the exchanged communication. The transport module 529 may be configured to transmit the endorsement indication over a designated communication channel distinct from the communication exchange channels. The transport module 529 may also be configured to provide the endorsement indication as a message or a notification such that a display of the endorsement notification is enabled through communication user experiences associated with the sender and the other recipients, further facilitated by the endorsement module 527. The program data 524 may also include, among other data, endorsement data 528, or the like, as described herein.

The computing device 500 may have additional features or functionality, and additional interfaces to facilitate communications between the basic configuration 502 and any desired devices and interfaces. For example, a bus/interface controller 530 may be used to facilitate communications between the basic configuration 502 and one or more data storage devices 532 via a storage interface bus 534. The data storage devices 532 may be one or more removable storage devices 536, one or more non-removable storage devices 538, or a combination thereof. Examples of the removable storage and the non-removable storage devices may include magnetic disk devices, such as flexible disk drives and hard-disk drives (HDD), optical disk drives such as compact disk (CD) drives or digital versatile disk (DVD) drives, solid state drives (SSD), and tape drives, to name a few. Example computer storage media may include volatile and nonvolatile, removable, and non-removable media implemented in any method or technology for storage of information, such as computer-readable instructions, data structures, program modules, or other data.

The system memory 506, the removable storage devices 536, and the non-removable storage devices 538 may be examples of computer storage media. Computer storage media may include, but may not be limited to, RAM, ROM, EEPROM, flash memory or other memory technology, CD-ROM, digital versatile disks (DVD), solid state drives, or other optical storage, magnetic cassettes, magnetic tape, magnetic disk storage or other magnetic storage devices, or any other medium which may be used to store the desired information and which may be accessed by the computing device 500. Any such computer storage media may be part of the computing device 500.

The computing device 500 may also include an interface bus 540 for facilitating communication from various interface devices (for example, one or more output devices 542, one or more peripheral interfaces 544, and one or more communication devices 546) to the basic configuration 502 via the bus/interface controller 530. Some of the example output devices 542 may include a graphics processing unit 548 and an audio processing unit 550, which may be configured to communicate to various external devices, such as a display or speakers via one or more A/V ports 552. One or more example peripheral interfaces 544 may include a serial interface controller 554 or a parallel interface controller 556, which may be configured to communicate with external devices, such as input devices (for example, keyboard, mouse, pen, voice input device, touch input device, etc.) or other peripheral devices (for example, printer, scanner, etc.) via one or more I/O ports 558. An example communication device 566 may include a network controller 560, which may be arranged to facilitate communications with one or more other computing devices 562 over a network communication link via one or more communication ports 564. The one or more other computing devices 562 may include servers, client equipment, and comparable devices.

The network communication link may be one example of a communication media. Communication media may be embodied by computer-readable instructions, data structures, program modules, or other data in a modulated data signal, such as a carrier wave or other transport mechanism, and may include any information delivery media. A “modulated data signal” may be a signal that has one or more of the modulated data signal characteristics set or changed in such a manner as to encode information in the signal. By way of example, and not limitation, communication media may include wired media such as a wired network or direct-wired connection, and wireless media such as acoustic, radio frequency (RF), microwave, infrared (IR), and other wireless media. The term computer-readable media, as used herein, may include both storage media and communication media.

The computing device 500 may be implemented as a part of a general purpose or specialized server, mainframe, or similar computer, which includes any of the above functions. The computing device 500 may also be implemented as a personal computer including both laptop computer and non-laptop computer configurations.

Example embodiments may also include methods to distribute endorsement indications in communication environments. These methods may be implemented in any number of ways, including the structures described herein. One such way may be by machine operations, using devices of the type described in the present disclosure. Another optional way may be for one or more of the individual operations of the methods to be performed in conjunction with one or more human operators performing some of the operations while other operations may be performed by machines. These human operators need not be co-located with each other, but each may be with a machine that performs a portion of the program. In other examples, the human interaction may be automated such as by pre-selected criteria that may be machine automated.

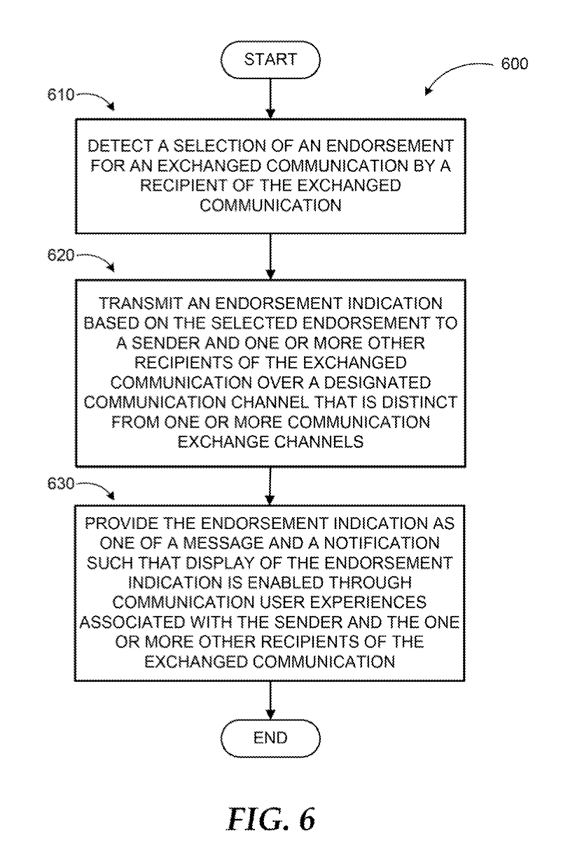

FIG. 6 illustrates a logic flow diagram for an example process of distributing endorsement indications in a communication environment, according to embodiments. Process 600 may be implemented by one or more communication services and/or their components executed on one or more servers or other computing devices.

Process 600 begins with operation 610, where a transport module associated with an endorsement module of a communication service may be configured to detect selection of an endorsement for an exchanged communication by a recipient of the exchanged communication. The selected endorsement may include a receipt acknowledgement and/or a social activity action associated with the exchanged communication. The social activity action may include a like, a dislike, and/or a mention, where the like and dislike may include various levels of like and dislike, for example.

At operation 620, the transport module may be configured to transmit an endorsement indication based on the selected endorsement to a sender and one or more other recipients of the exchanged communication. The transport module may transmit the endorsement indication over a designated communication channel that is distinct from one or more communication exchange channels over which communications are exchanged. For example, the designated communication channel may be a control messaging channel in a transport layer of the communication service, for example, where standard format/schema for control messages may be employed that distinguishes the control messages from normal communications and contains other relevant data. For example, a control message may include an action to be performed and metadata associated with the action, where the action may be generation of an endorsement indication and the metadata may include information associated with selected endorsements. A sending component of the transport module at the mailbox associated with the recipient may be configured to transmit the control message over the designated communication channel. A receiving component of the transport module, such as transport delivery agent, may intercept the control message and process the metadata of the control message to create an endorsement indication at a destination mailbox, such as the individual mailboxes of the sender and the other recipients, and/or a shared mailbox of the group comprising the sender and the other recipients. The endorsement indication may be stored in a database associated with the destination mailbox such that the endorsement indication may be persisted.

At operation 630, a broker component of the transport module may be configured to provide the endorsement indication as a message or a notification such that display of the endorsement indication may be enabled through communication user experiences associated with the sender and the other recipients.

The operations included in process 600 are for illustration purposes. A communication service distributing endorsement indications according to embodiments may be implemented by similar processes with fewer or additional steps, as well as in different order of operations using the principles described herein. The operations described herein may be executed by one or more processors operated on one or more computing devices, one or more processor cores, specialized processing devices, and/or general purpose processors, among other examples.

A means for distribution of endorsement indications in a communication environment may include a means for detecting a selection of an endorsement for an exchanged communication by a recipient of the exchanged communication, a means for transmitting an endorsement indication based on the selected endorsement to a sender and one or more other recipients of the exchanged communication over a designated communication channel that is distinct from one or more communication exchange channels over which one or more communications, including the exchanged communication, are exchanged, and a means for providing the endorsement indication as a message or a notification such that display of the endorsement indication is enabled through communication user experiences associated with the sender and the other recipients of the exchanged communication.

According to some embodiments, computing devices to distribute endorsement indications in a communication environment are described. An example computing device may include a memory configured to store instructions, and one or more processors coupled to the memory that are configured to execute a communication service, where the communication service includes a communication module, an endorsement module, and a transport module associated with the endorsement module. The communication module may be configured to facilitate exchange of one or more communications within a conversation over one or more communication exchange channels. The endorsement module may be configured to enable a recipient to select an endorsement for an exchanged communication. The transport module may be configured to detect the selection of the endorsement for the exchanged communication by the recipient, transmit an endorsement indication based on the selected endorsement to a sender and one or more other recipients of the exchanged communication over a designated communication channel that is distinct from the one or more communication exchange channels, and provide the endorsement indication as a message or a notification such that display of the endorsement indication is enabled through communication user experiences associated with the sender and the other recipients of the exchanged communication.

In other examples, the exchanged communication may be an email exchange, a meeting invite, a shared contact card, a shared task, a text message exchange, an online conference, an audio communication, a video communication, an application sharing session, a desktop sharing session, and/or a data sharing session. The endorsement may be a receipt acknowledgement or a social activity action. The social activity action may be a like, a dislike, or a mention, where the like and dislike social activity actions may include one or more respective levels of like and dislike. The endorsement indication may include the recipient, the selected endorsement, the exchanged communication, a group associated with the exchanged communication, and/or a time elapsed from the selection of the endorsement. The designated communication channel may be a control messaging channel in a transport layer of the communication service.

According to some embodiments, methods executed on one or more computing devices to distribute endorsement indications in a communication environment are provided. An example method may include detecting a selection of an endorsement for an exchanged communication by a recipient of the exchanged communication, transmitting an endorsement indication based on the selected endorsement to a sender and one or more other recipients of the exchanged communication over a designated communication channel that is distinct from one or more communication exchange channels over which one or more communications, including the exchanged communication, are exchanged, and providing the endorsement indication as a message or a notification such that display of the endorsement indication is enabled through communication user experiences associated with the sender and the other recipients of the exchanged communication.

In other embodiments, the endorsement indication may be transmitted to individual mailboxes or a shared mailbox associated with the sender and the other recipients. The endorsement indication may be stored in a database associated with the individual mailboxes or the shared mailbox associated with the sender and the other recipients such that the endorsement indication is persisted. The endorsement indication may be aggregated with other endorsement indications for the exchanged communication within the database.

In further embodiments, a control message may be transmitted to the sender and the other recipients over the designated communication channel. The control message may be distinct from the exchanged communication, and includes one or more instructions for an action to be performed and metadata associated with the action. The action to be performed may be generation of the endorsement indication and the metadata may include information associated with the selected endorsement. The metadata may include an endorser, a type of the selected endorsement, the exchanged communication, a group associated with the exchanged communication, and/or a time of endorsement selection. The metadata of the control message may be processed to generate the endorsement indication.

According to some examples, systems configured to distribute endorsement indications in a communication environment are described. An example system may include a first server associated with a recipient of an exchanged communication, a second server associated with one of a sender and one or more other recipients of the exchanged communication, and a transport module associated with the first server and/or the second server configured to distribute an endorsement indication based on an endorsement for the communication selected by the recipient at the first server to the second server. The transport module may include a sending component configured to transmit a control message to the second server over a designated communication channel, where the control message includes an instruction to generate the endorsement indication and metadata associated with the selected endorsement. The transport module may also include a receiving component configured to intercept the control message at the second server, and process the metadata of the control message to generate the endorsement indication. The transport module may further include a broker component configured to provide the endorsement indication as a message or a notification to a client of the second server such that a display of the endorsement indication is enabled for the one of the sender and the other recipients of the exchanged communication.

In other examples, the endorsement indication may be stored in a data store associated with the second server. The receiving component may be a transport delivery agent. The first server and the second server may be computing devices, each of the computing devices including a memory, one or more processors, and/or a communication module configured to facilitate exchange of one or more communications within a conversation over one or more communication exchange channels.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

What is claimed is:

1. A computing device to distribute endorsement indications in a communication environment, the computing device comprising:
a memory configured to store instructions; and
one or more processors coupled to the memory that are configured to execute a communication service, wherein the communication service comprises:
a communication module configured to facilitate exchange of one or more communications within a conversation over one or more communication exchange channels;
an endorsement module configured to enable a recipient to select an endorsement for an exchanged communication; and
a transport module associated with the endorsement module, the transport module configured to:
detect the selection of the endorsement for the exchanged communication by the recipient;
transmit an endorsement indication based on the selected endorsement to a sender and one or more other recipients of the exchanged communication over a designated communication channel that is distinct from the one or more communication exchange channels; and
provide the endorsement indication as one of a message and a notification such that display of the endorsement indication is enabled through communication user experiences associated with the sender and the one or more other recipients of the exchanged communication.

2. The computing device of claim 1, wherein the exchanged communication is one or more of an email exchange, a meeting invite, a shared contact card, a shared task, a text message exchange, an online conference, an audio communication, a video communication, an application sharing session, a desktop sharing session, and a data sharing session.

3. The computing device of claim 1, wherein the endorsement is one or more of a receipt acknowledgement and a social activity action.

4. The computing device of claim 3, wherein the social activity action is one of a like, a dislike, and a mention.

5. The computing device of claim 4, wherein the like and dislike social activity actions include one or more respective levels of like and dislike.

6. The computing device of claim 1, wherein the endorsement indication includes one or more of the recipient, the selected endorsement, the exchanged communication, a group associated with the exchanged communication, and a time elapsed from the selection of the endorsement.

7. The computing device of claim 1, wherein the designated communication channel is a control messaging channel in a transport layer of the communication service.

8. A method executed on a computing device to distribute endorsement indications in a communication environment, the method comprising:
detecting a selection of an endorsement for an exchanged communication by a recipient of the exchanged communication;
transmitting an endorsement indication based on the selected endorsement to a sender and one or more other recipients of the exchanged communication over a designated communication channel that is distinct from one or more communication exchange channels over which one or more communications, including the exchanged communication, are exchanged;
providing the endorsement indication as one of a message and a notification such that display of the endorsement indication is enabled through communication user experiences associated with the sender and the one or more other recipients of the exchanged communication; and
enabling removal of the endorsement indication by the sender or the one or more other recipients of the exchanged communication.

9. The method of claim 8, wherein transmitting the endorsement indication comprises:
transmitting the endorsement indication to one of individual mailboxes or a shared mailbox associated with the sender and the one or more other recipients.

10. The method of claim 9, further comprising:
storing the endorsement indication in a database associated with the one of the individual mailboxes or the shared mailbox associated with the sender and the one or more other recipients such that the endorsement indication is persisted.

11. The method of claim 10, further comprising:
aggregating the endorsement indication with one or more other endorsement indications for the exchanged communication within the database.

12. The method of claim 8, wherein transmitting the endorsement indication further comprises:
transmitting a control message to the sender and the one or more other recipients over the designated communication channel.

13. The method of claim 12, wherein the control message is distinct from the exchanged communication, and includes one or more instructions for an action to be performed and metadata associated with the action.

14. The method of claim 13, wherein the action to be performed is generation of the endorsement indication and the metadata includes information associated with the selected endorsement.

15. The method of claim 13, wherein the metadata includes one or more of an endorser, a type of the selected endorsement, the exchanged communication, a group associated with the exchanged communication, and a time of endorsement selection.

16. The method of claim 13, further comprising:
processing the metadata of the control message to generate the endorsement indication.

17. A system configured to distribute endorsement indications in a communication environment, the system comprising:
a first server associated with a recipient of an exchanged communication;
a second server associated with one of a sender and one or more other recipients of the exchanged communication; and
a transport module associated with at least one of the first server and the second server, the transport module configured to distribute an endorsement indication based on an endorsement for the communication selected by the recipient at the first server to the second server, the transport module comprising:
a sending component configured to transmit a control message to the second server over a designated communication channel, wherein the control message includes an instruction to generate the endorsement indication and metadata associated with the selected endorsement;
a receiving component configured to:
intercept the control message at the second server; and
process the metadata of the control message to generate the endorsement indication; and
a broker component configured to provide the endorsement indication as one of a message and a notification to a client of the second server such that a display of the endorsement indication is enabled for the one of the sender and the one or more other recipients of the exchanged communication.

18. The system of claim 17, wherein the receiving component is further configured to:
store the endorsement indication in a data store associated with the second server.

19. The system of claim 17, wherein the receiving component is a transport delivery agent.

20. The system of claim 17, wherein the first server and the second server are computing devices, each of the computing devices comprising at least a memory, one or more processors, and a communication module configured to facilitate exchange of one or more communications within a conversation over one or more communication exchange channels.
